(19) United States
(12) Patent Application Publication
(10) Pub. No.: US 2020/0266434 A1
(43) Pub. Date: Aug. 20, 2020

(54) DISSOLUTION RESISTANT NANOPOROUS LITHIUM MANGANESE OXIDE

(71) Applicant: THE REGENTS OF THE UNIVERSITY OF CALIFORNIA, Oakland, CA (US)

(72) Inventors: Sarah Tolbert, Los Angeles, CA (US); Benjamin Lesel, Los Angeles, CA (US)

(73) Assignee: THE REGENTS OF THE UNIVERSITY OF CALIFORNIA, Oakland, CA (US)

(21) Appl. No.: 16/678,156

(22) Filed: Nov. 8, 2019

Related U.S. Application Data
(63) Continuation of application No. PCT/US2018/033281, filed on May 17, 2018.
(60) Provisional application No. 62/507,739, filed on May 17, 2017.

(51) Int. Cl. H01M 4/505; H01M 10/0525; H01M 4/04

(52) U.S. Cl. CPC H01M 4/505; H01M 4/0471; H01M 10/0525

(57) ABSTRACT

Scalable pseudocapacitive cathode materials are provided that can be effectively paired with pseudocapacitive anode materials and used to produce fast charging, long cycle lifetime lithium ion batteries. A sol-gel templating method which forms materials with dissolution resistant surfaces that can avoid capacity loss due to dissolution in high surface area nanostructured LiMn₂O₄ powders, is also provided. The materials have a long needle-like morphology with dominant <111> surface sites and demonstrate higher capacity and less dissolution than similarly sized materials synthesized with a different structure.

### CROSS-REFERENCE TO RELATED APPLICATIONS

This application claims priority to, and is a 35 U.S.C. § 111(a) continuation of, PCT international application number PCT/US2018/033281 filed on May 17, 2018, incorporated herein by reference in its entirety, which claims priority to, and the benefit of, U.S. provisional patent application Ser. No. 62/507,739 filed on May 17, 2017, incorporated herein by reference in its entirety. Priority is claimed to each of the foregoing applications.

The above-referenced PCT international application was published as PCT International Publication No. WO 2018/213644 on Nov. 22, 2018, which publication is incorporated herein by reference in its entirety.

### STATEMENT REGARDING FEDERALLY SPONSORED RESEARCH OR DEVELOPMENT

This invention was made with government support under Grant Number DE-SC0014213, awarded by the U.S. Department of Energy. The government has certain rights in the invention.

### BACKGROUND

### 1. Technical Field

The technology of this disclosure pertains generally to charge storage electrode materials and fabrication methods, and more particularly to methods for the production of dissolution resistant, nanostructured, pseudocapacitive Lithium Manganese Oxide (LMO) electrode materials and nanostructured materials suitable for use as cathodes for lithium ion batteries and pseudocapacitors.

### 2. Background Discussion

Improvements in battery technology are essential to meet the demand for providing power to a wide range of mobile electronics and electric vehicles. Innovations in battery operated devices have increased the demand for faster recharge times without greatly diminishing energy density.

Typically, electrochemical energy is stored through either double layer capacitance in a capacitor or through faradic reactions in the form of batteries. Capacitors can charge very quickly but have low energy density, whereas batteries have high energy density but charge slowly. For example, the standard Li-ion battery that is found in most mobile devices has a reasonable energy density, but requires charging on the hour time-scale. Capacitors are capable of charging on the seconds time-scale, but have low energy density.

To bridge the gap between energy density and fast charging times, attempts have been made to either make capacitors store more energy or make batteries charge faster. Efforts to increase the energy density of capacitors have been largely concentrated in increasing the surface area of materials to produce supercapacitors. Currently, carbon based double layer supercapacitors are used in most high power applications, but these materials have significantly lower energy densities than lithium ion batteries. Unfortunately, conventional supercapacitors can only achieve approximately 10% of the energy density of lithium ion batteries and thus still require major improvements before they can be used for most mobile applications.

Improvements, particularly in charging speed and cyclability of Li-ion batteries, are desired for broadened and sustained use of these batteries. The root cause for slow charging in commercial lithium ion batteries is the slow solid state lithium ion diffusion through the electrode materials. Reducing these solid state Li-ion diffusion distances by fabricating smaller sized electrode powders may lead to improved kinetics. In a typical lithium ion battery, charge and discharge times are kinetically limited by long Li-ion solid state diffusion through micron-length-scale powders in the cathode material.

Pseudocapacitive charge storage has the potential for allowing faster charge-discharge rates than conventional battery materials while retaining energy densities much greater than that found in double layer type supercapacitors. When fast kinetics are observed in electrode materials, the term pseudocapacitance is used to describe the fast near surface redox reactions. When these near surface redox reactions extend into the bulk of a nanoscale material and occur without a structural phase transition, the fast insertion (intercalation) and removal (detercalation) of Li-ions within the material has been termed intercalation pseudocapacitance. The primary advantage of intercalation pseudocapacitance is that it utilizes the bulk of the nanostructured material, not just the surface, thus allowing greater energy density to be realized in combination with increased power density.

In order for pseudocapacitance to occur, several conditions must exist, including small diffusion distances that are well matched to the diffusion constant of the material; interconnectivity between the grains into a nanoporous network for easy electron transport; sufficient space or porosity between grains to the electrolyte to access all surface and nanoscale domains; and a suppression of any first order phase transition that might occurs in bulk systems during redox processes.

To date, however, many quantified examples of intercalation pseudocapacitance have been with materials that show redox in potential ranges more suitable for applications as anode materials rather than as cathode materials. To create a full cell battery capable of pseudocapacitive kinetics, equivalent fast charging pseudocapacitve cathode materials must be developed to pair with the anodes.

One reason for the lack of pseudocapacitive cathode materials is the high crystallization temperature required to synthesize most cathode materials. Accordingly, nanostructured or nanoporous cathode materials capable of achieving pseudocapacitance are rare since most require high temperatures (700° C.+) to form the proper crystalline phase, and high temperatures tend to coarsen and destroy fine nanostructure.

In general, improving nano-scale architectures for intercalation pseudocapacitance has been complex and requires optimization of many parameters. Simply reducing the grain size of a powder from the micron-scale to the nano-scale is not enough to improve kinetics. For example, a typical slurry electrode consists of active material powder, conductive additives such as carbon black, and a binder such as PVDF. Active material consisting of individual nano-sized grains incorporated into the slurry can produce electrodes that are kinetically slow due to poor electrical conductivity between nanosized grains and reduced electrolyte penetration into regions of agglomerated nanoparticles, even though Li-ion diffusion lengths within each domain are short.

In addition, new issues can arise due to the increased surface area with many nanostructured systems. Specifically, either reduced or oxidized electrochemically inactive surfaces can form which can reduce overall capacity in systems with high surface areas. Anode materials can have oxidized surfaces, such as MoO₂ with an inactive MoO₃ surface or Si with an inactive SiO₂ surface, for example. In contrast, cathode materials can have reduced surfaces, such as LiCoO₂ and LiMn₂O₄, which show surface Co²⁺ and Mn²⁺, respectively, while the bulk is composed entirely of 3+ and 4+ transition metal ions.

In addition to shorten solid state diffusion distances, the fast kinetics of intercalation pseudocapacitance generally require electrical interconnections between the active material grains and effective electrolyte penetration between the particles to reach all surface area. For materials that normally undergo phase transitions upon Li+ cycling, suppression of those phase transitions in finite size is also needed.

When the crystallite size is sufficiently small, suppression of phase transition can occur. This phase suppression is important, since phase transitions that occur via nucleation and growth can play a major role in the sluggish kinetics of bulk Li-ion intercalation and detercalation. When a phase transition proceeds via nucleation and growth, propagation of the phase front can become the rate limiting step in solid state lithium ion diffusion. Additionally, phase transitions can cause structural deterioration with each cycle, which can contribute to capacity fade over many cycles. The mechanism of capacity reduction from phase transitions has been associated the fracturing of particles, which lose contact to the electrode matrix.

For example, one of the most widely used cathode materials for lithium ion batteries is LiCoO₂. LiCoO₂, along with many other materials of the form LiMO₂ (where M is a transition metal), are layered and show good cycling stability in bulk, but often do not show reliable cycling stability when nanostructured for fast lithium ion intercalation. One reason for this is that the insertion and removal of lithium ion can result in a phase transition between trigonal and monoclinic lattice structures.

Despite these problems, fabrication of nanostructured cathode materials capable of intercalation pseudocapacitance is necessary for the creation of full cell, fast charging, Li-ion batteries.

### BRIEF SUMMARY

The present technology provides pseudocapacitive electrode materials based on LiMn₂O₄ and methods for synthesis of such nanoporous materials for use as a cathode material for lithium ion batteries, for example. The methods are inexpensive, environmentally benign and scalable.

LiMn₂O₄ is an established cathode material, but it is often overlooked as a commercial cathode material due to its poor cycling ability in bulk that occurs as a result of manganese (Mn) dissolution into the electrolyte upon cycling. The nanoporous version of LiMn₂O₄ produced with the methods described here avoids the poor cycling ability of its bulk counterpart and retains its capacity for a greater number of cycles

Many conventional cathode materials have crystallization temperatures of 700° C. or higher, which impede the formation of nanostructures. By comparison, LiMn₂O₄ is, in general, a superior material for producing nanostructures since it has a crystallization temperature that is lower than required in the formation of typical cathode materials.

Advantageously, the method of producing nanoporous LiMn₂O₄ of some embodiments is streamlined and avoids numerous processing stages that would be unfavorable to scale-up and avoids use of toxic and expensive reagents. In the method of some embodiments, a polymeric template is inexpensive to produce and environmentally friendly, and the method is streamlined to a few processing stages.

A benefit of nanoporous electrode materials is the provision for faster charging and discharging times, up to an order of a magnitude greater than that of other bulk electrode materials, and, in the case of LiMn₂O₄, the nanostructured version of this material also significantly reduces capacity fade with multiple cycles. Although nanostructured LiMn₂O₄ may not yield charging times for a battery as fast as a capacitor, this material has the benefit of having a higher energy density than a capacitor by about five times, and yields at least about two-thirds of a capacity of a commercial battery. Thus, nanostructured LiMn₂O₄ allows for energy storage applications where a higher capacity than capacitors is desired, but faster charging times and longer lifetimes than conventional batteries are desired.

In some embodiments, the nanoporous LiMn₂O₄ shows improvement over lithium iron phosphate (LFP) in cycle lifetime (e.g., LFP yields about 80% capacity retention after 2000 cycles, while the nanostructured LiMn₂O₄ retains at least or above about 90% after 3000 cycles), charging time (e.g., charging time of LFP is about 30 minutes, while charging time of the nanostructured LiMn₂O₄ to about 90% of maximum capacity is about 6 minutes) and discharge voltage (e.g., average discharge voltage of LFP is about 2.8 V, while average discharge voltage of the nanostructured LiMn₂O₄ is about 3.7 V).

It is well known that structural changes occur in bulk LiMn₂O₄ during cycling, including a two-phase coexistence and modest lattice expansions/contractions upon lithium detercalation/intercalation, respectively. It is believed that the observed disturbance in the structure due to this phase change and two-phase co-existence is responsible for the poor cyclability observed in bulk LiMn₂O₄ systems. Additionally, previous reports have used indirect methods to show that phase changes in nanoparticles of LiMn₂O₄ below 40 nm in size are suppressed upon Li+ addition to the structure (<3 V vs Li/Li+). This suppression, however, has not previously been demonstrated for the primary voltage region in LiMn₂O₄ above 3 V vs Li/Li+ where Li+ is removed during cycling.

The phase transition suppression in the small domain size material leads to both improved cyclability and improved charge storage kinetics. The critical point at which phase change suppression and thus intercalation pseudocapacitance emerges for LiMn₂O₄ crystallites was estimated to be between 40 nm and 50 nm. Therefore, nanostructured material with crystalline grain sizes below 40 nm in diameter are preferred.

Nanostructured LiMn₂O₄ below about 50 nm in size can be prone to lower capacity due to dissolution of surfaces of nanostructures during a first cycle before a solid-electrolyte-interphase has formed over the nanostructures. The (111) surface has been shown to be resistant to dissolution in common Li-ion electrolytes. Therefore, synthesizing nanostructured LiMn₂O₄ with selectively more (111) surface sites results in higher capacity for the resulting material. Dopants may also confer some dissolution resistance as well.

The preferred methods provide a polymer term plated, aqueous sol-gel synthesis methods where nanoporous LiMn₂O₄ materials are formed with and without dominant (111) surface faceting for use as cathode materials for lithium ion batteries. The nanostructured LiMn₂O₄ powders produced using acetate salt precursors showed no faceting and had a rounded morphology (R-LMO) with no dominant facets. The nanostructured LiMn₂O₄ powder produced using nitrate salt precursors formed needle-like morphology (N-LMO) with (111) dominant faceting along the length of the needles.

This (111) surface dominated structure shows all the benefits of nanostructuring LiMn₂O₄, including fast rate kinetics and improved cycle life-time, as well as being more resistant to dissolution and therefore retains more capacity than a structure without the (111) surface selectivity. The structural and electrochemical properties of both R-LMO and N-LMO were also demonstrated.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1 is a functional block diagram a method for fabricating dissolution resistant, nanostructured, pseudocapacitive electrode materials according to one embodiment of the technology.

FIG. 2 is a scanning electron micrograph of LiMn₂O₄ showing needle-like nanostructure with predominant (111) surfaces produced with processing according to the steps of FIG. 1.

FIG. 3 is a transmission electron micrograph of LiMn₂O₄ (N-LMO) nanoneedle showing lattice spacing of <111> and the parallel (111) surface facets and dissolution susceptible surfaces.

FIG. 4 is porosimetry graph of the N-LMO material showing a flat distribution of pores below 50 nm, corresponding to a broad range of pores sizes. There is also a peak at 60 nm corresponding to large mesopores or small macropores in this system.

FIG. 5 is a schematic side view of a battery or pseudocapacitor including a cathode, an anode, and a separator and electrolyte that is disposed between the cathode and the anode.

FIG. 6 is a plot of galvanostatic discharge at 1 C showing disparity in capacity between N-LMO and R-LMO materials.

### DETAILED DESCRIPTION

Referring more specifically to the drawings, for illustrative purposes, embodiments of materials and methods for the synthesis of nanoporous LiMn₂O₄ materials and dissolution resistant electrodes that are capable of pseudocapacitive charge/discharge kinetics and long cycle lifetimes are generally shown. The methods provide control the electrochemical properties of nanostructured LiMn₂O₄ systems using both nanoscale architecture and surface structure to improve capacity without harming cycling kinetics.

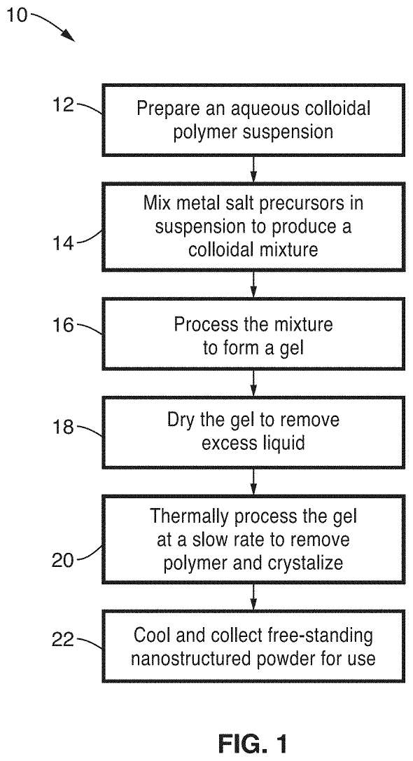

Several embodiments of the technology are described generally in FIG. 1 to FIG. 6 to illustrate the characteristics and functionality of the electrode materials and systems. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

The synthesis of nanoporous LiMn₂O₄ powders is used to illustrate the technology. In some embodiments, a method for producing a nanostructured LiMn₂O₄ includes: (1) combining a lithium-containing reagent and a manganese-containing reagent with a solution of a polymeric template to obtain a mixture; and (2) processing the mixture to form the nanostructured LiMn₂O₄.

Turning now to FIG. 1, a flow diagram of one embodiment of a method 10 for the fabrication of LiMn₂O₄ crystallite powders and nanostructured electrodes is shown schematically. Initially, a preferably colloidal suspension of a polymeric template in an aqueous solvent is prepared in the step at block 12 of FIG. 1. In some embodiments, the solution of the polymeric template includes polymeric colloids or micelles dispersed in water or other liquid medium, such as colloids having sizes less than about 300 nm, or in a range of about 10 nm to about 290 nm. Other amphiphilic polymers or combinations of hydrophilic and hydrophobic polymers can be used as the colloidal or micellar template.

One particularly preferred polymer template at block 12 is an aqueous colloidal suspension of 60 nm to 80 nm diameter poly(methylmethacrylate) (PMMA) nanospheres with a concentration of about 50 mg/mL. In another embodiment, a mixture of two different polymers provide the polymer template nanospheres. The size of the two types of polymer template particles can be similar or substantially different.

Metal salt precursors are dissolved into the polymer suspension to produce a colloidal mixture at block 14 of FIG. 1. In this illustration, lithium and manganese metal atoms are the desired metals. However, other metal salts can be used in the formation of the material with the process. In some embodiments, the lithium-containing precursor is a lithium-containing salt, such as lithium nitrate or lithium acetate. In some embodiments, the manganese-containing precursor is a manganese-containing salt, such as manganese nitrate or manganese (II) nitrate tetrahydrate. In one embodiment, a molar ratio of the manganese-containing reagent to the lithium-containing reagent is in a range of about 1.5 to about 2.5, or preferably about 2.

In some embodiments, resistance to dissolution is attained through incorporation of one or more additional metals different from lithium and manganese as dopants. Additional metals can be incorporated as metal ions, such as, for example, magnesium (Mg), ruthenium (Ru), or other alkaline earth metals or other transition metals, and are added in proper amounts (e.g., about 5 molar %) into the mixture in the form of, for example, metal salts.

The mixture of metal salt precursors and colloidal polymer suspension is processed, usually by aging via stirring and/or heating, to evaporate off water or other solvent and form a cohesive gel at block 16.

If necessary, the gel may be dried at block 18 to remove excess solvent before the final processing steps. The time required for drying the gel will vary depending on the precursor, polymer suspension and solvent materials that are used.

The dried gel is then processed thermally, typically by heating in a furnace, to remove the polymer template and to crystallize the material into a porous nanostructure at block 20. Heating of the assembled material at block 20 allows for fusion of the active materials into a continuous matrix with pores left behind by the removal of the template.

Thermal processing at block 20, preferably takes place at a slow rate with a ramp period and a soak period. The ramp period is the time it takes to reach a target temperature from a starting temperature. The soak period is the time that the material resides at the achieved target temperature. The preferred range of target/soak temperatures is between approximately 350° C. and approximately 750° C. and about 500° C. and approximately 550° C. is particularly preferred in the context of the fabrication of LiMn₂O₄ materials. Ramp rates and soak periods may be optimized based on the materials that are used.

The preferred ramp rate is between approximately 50° C./h and approximately 100° C./h to reach the selected target temperature. Soak periods may be within the range of about 30 hours to less than one hour. In some embodiments, soak heating is performed at a temperature in a range of about 350° C. to about 700° C., about 350° C. to about 650° C., about 400° C. to about 600° C., about 450° C. to about 550° C., or about 400° C. to 500° C., for a time duration in a range of about 1 hour to about 30 hours, about 5 hours to about 30 hours, about 10 hours to about 25 hours, or about 10 hours to about 20 hours. Soak periods of a range of about 1 hour to about 10 hours are particularly preferred.

Finally, at block 22 of FIG. 1, the formed nanoporous material is cooled and removed from the reaction container. The powdered nanoporous LiMn₂O₄ may include elongated LiMn₂O₄ nanostructured grains within the material. In some embodiments, the nanostructures have lateral dimensions (or an average lateral dimension) in a range of about 1 nm to about 100 nm, about 1 nm to about 50 nm, about 1 nm to about 40 nm, about 1 nm to about 30 nm, about 1 nm to about 20 nm, or about 6 nm to about 20 nm, and longitudinal or lengthwise dimensions (or an average longitudinal dimension) greater than the lateral dimensions (or the average lateral dimension). The method can also produce free-standing nanostructured powders with grain sizes outside of the nanocrystalline range (>100 nm), that are still considered nanostructured materials.

In some embodiments, the nanostructures have aspect ratios (or an average aspect ratio) of about 1.5 or greater, about 2 or greater, about 3 or greater, or about 5 or greater, and up to about 10 or greater, or up to about 50 or greater. In some embodiments, the nanostructures include (111) crystal facets or surfaces at least partially exposed along lateral peripheries of the nanostructures. In some embodiments, the nanostructures include (111) crystal facets or surfaces substantially aligned with longitudinal or lengthwise directions of the nanostructures. In some embodiments, the resulting nanostructured LiMn₂O₄ includes LiMn₂O₄ nanostructures having other morphologies and which are rendered resistant to dissolution through incorporation of one or more additional metals different from lithium and manganese.

The resulting structure from this synthesis will vary depending on the metal salts that are used, if acetate salt precursors such as lithium acetate dihydrate and manganese (II) acetate are used, for example, the nanostructured LiMn₂O₄ powders show no faceting and have a rounded morphology with no dominant facets.

If nitrate salts are used (e.g. lithium and manganese nitrates), the porous network is composed of interconnected spikey balls with needle-like projections that can form large nanopores (e.g. pores>50 nm in size) occurring between the templated needled balls. Smaller nanopores in the 2 nm to 50 nm range occur between needles. The overall nanoporous architecture is formed by a combination of polymer templating and crystallization induced faceting.

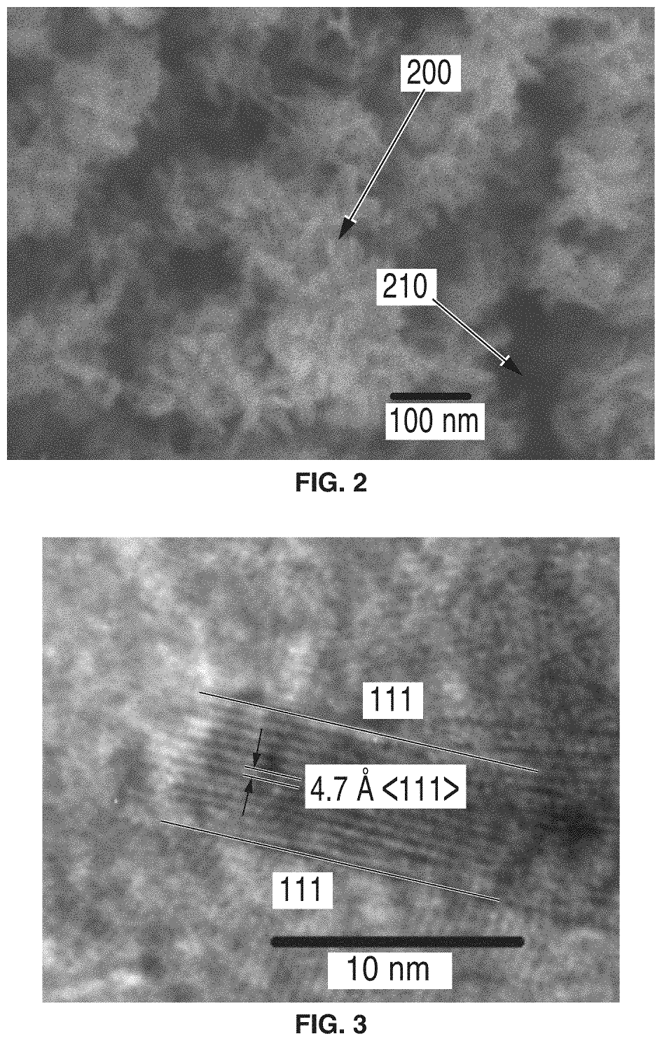

The morphology of the nanoporous LiMn₂O₄ powder produced using nitrate salt precursors form a needle-like morphology (N-LMO) with (111) dominant faceting along the length of the needles as shown in FIG. 2 and in detail in FIG. 3. As seen in FIG. 2, the crystalline grains have radiating needle structures 200 with dominant (111) facets forming the porous nanostructure. These needle structures 200 result in both a higher surface area and a higher pore volume as compared with other porous materials that do not have needles. Both the large pores 210 between the needled particles and the smaller pores between needles are a result of the colloidal polymer templating combined with nitrate-salt faceting.

A closer look at the morphology of the nanostructures in the TEM images of FIG. 3 shows that the needle-like structures of the N-LMO have the <111> lattice traveling parallel to the long direction, thus the surfaces all along the length of the structures correspond to (111) surfaces, with only the ends displaying non-(111) surfaces. Surfaces intersecting the <111> lattice planes are terminated with other faces such as (110) or (001). The N-LMO material thus displays dominant (111) surface character, since the length is significantly longer than the radius.

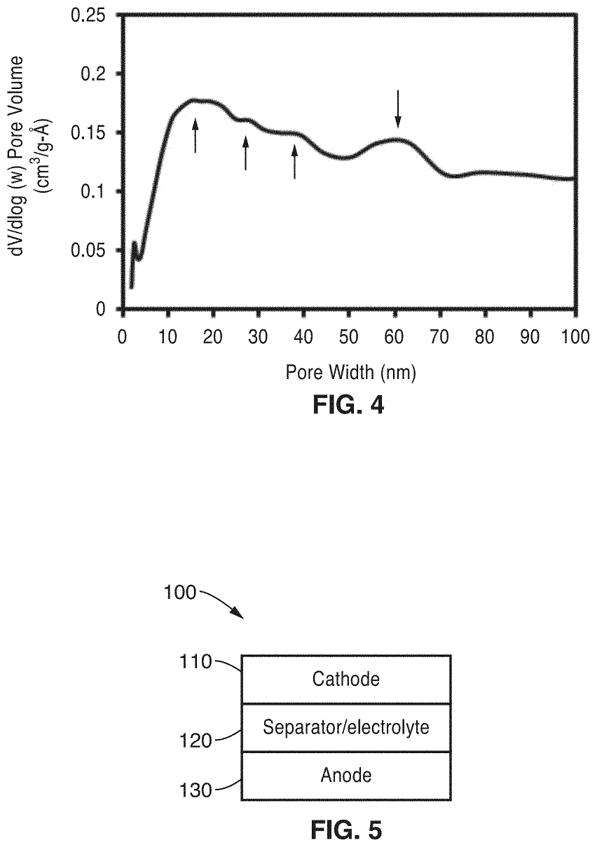

Because porosimetry will measure any free space within a material, the spaces between the needles gives a distribution as shown in FIG. 4. As can be seen in FIG. 4, a broad distribution is observed below 50 nm, corresponding to the spaces between the needles as indicated with upward directed arrows in FIG. 4. A peak above 50 nm represents the larger mesopores or small macropores in this system as indicated with the downward directed arrow in FIG. 4.

In all embodiments, the resulting nanoporous LiMn₂O₄ includes a network of interconnected LiMn₂O₄ nanostructures and having a porosity deriving from open spaces in the nanostructured LiMn₂O₄ (e.g., between the LiMn₂O₄ nanostructures). The porosity (corresponding to a fraction of a total volume deriving from the open spaces) can be determined from porosimetry, and can be in a range of about 0.05 to about 0.95, about 1 to about 0.9, about 0.2 to about 0.8, about 0.3 to about 0.7, or about 0.4 to about 0.6. The porosity is desirable to allow electrolyte penetration into the nanostructured LiMn₂O₄. Dimensions of the open spaces can be in the nanoscale, such as in a range of about 1 nm to about 300 nm, about 1 nm to about 200 nm, about 1 nm to about 100 nm, about 1 nm to about 50 nm, or about 20 nm.

Nanostructured LiMn₂O₄ with domain sizes below about 50 nm in size can be prone to lower capacity due to dissolution of surfaces of nanostructures during a first cycle before a solid-electrolyte-interphase has formed over the nanostructures. Advantageously, the nanostructured LiMn₂O₄ of some embodiments exhibits higher capacity than otherwise attained for such small crystallite sizes (e.g., about 10 nm) because elongated (e.g., needle-like) nanostructures have (111) crystal orientation along a length of the nanostructures, which is shown to be resistant to dissolution. The resistance to dissolution results in greater capacity.

The nanoporous LiMn₂O₄ described herein can be used for a variety of batteries and other energy storage devices including pseudocapacitors. For example, the nanostructured LiMn₂O₄ can be used as an active cathode material in a lithium ion battery. As shown in an embodiment of FIG. 5, a resulting battery can include a cathode, an anode, and a separator that is disposed between the cathode and the anode. The battery also can include an electrolyte, which is disposed between the cathode and the anode. The cathode can include the nanostructured LiMn₂O₄ described herein.

In another example, the nanostructured LiMn₂O₄ can be used as an active cathode material in a lithium ion pseudocapacitor. As shown in an embodiment of FIG. 5, a resulting pseudocapacitor can include a cathode, an anode, and a separator that is disposed between the cathode and the anode. The pseudocapacitor also can include an electrolyte, which is disposed between the cathode and the anode. The cathode can include the nanostructured LiMn₂O₄ described herein.

In some embodiments, the method includes applying the mixture onto a substrate to form a coating over the substrate, and heating the coating to form the nanostructured LiMn₂O₄ over the substrate. In some embodiments, the substrate is a conductive substrate, such as a conductive glass substrate, a conductive carbon substrate, or a metallic substrate. In some embodiments, applying the mixture onto the substrate includes forming the coating as a wet gel over the substrate. In some embodiments, the nanostructured LiMn₂O₄ is formed first, and then is cast or otherwise applied onto the substrate as a slurry containing conductive additives and a binder.

The technology described herein may be better understood with reference to the accompanying examples, which are intended for purposes of illustration only and should not be construed as in any sense limiting the scope of the technology described herein as defined in the claims appended hereto.

### Example 1

In order to demonstrate the operational principles of the dissolution resistant electrode materials and synthesis methods, predominantly (111) surface nanostructured LiMn₂O₄ powders were produced using the processing steps shown generally in FIG. 1. Synthesis of predominantly (111) surface nanostructured LiMn₂O₄ was performed to demonstrate the methods and illustrate the needle morphology.

The illustrative material was prepared by mixing about 2.2 mmol of lithium nitrate and about 4.0 mmol of manganese (II) nitrate with about 7.5 mL of an about 50 mg/mL aqueous solution of colloidal poly(methyl methacrylate) (PMMA, less than about 300 nm in colloid size). The mixture was then heated and stirred in a round bottom flask for about 20 minutes at about 90° C. in an oil bath. The resulting mixture was poured onto a substrate (such as a borosilicate petri dish or steel plate) and left to dry for several hours in a fume hood until it became a solid gel. The resulting solid gel was heated in a furnace in air with a ramp of about 50° C./hour from room temperature to about 500° C. or above and thereafter soaked for a period of about 1 hour to 10 hours. The resulting nanostructured LiMn₂O₄ powder was obtained by carefully scraping the solid from the fabrication substrate surface.

Analysis of the powder found the powder to be substantially pure LiMn₂O₄ with a crystallite size between about 6 nm to about 20 nm, a nano-sized porosity, and a surface area between about 10 and about 60 m²/g. SEM and TEM images of representative LiMn₂O₄ nanostructures were also obtained. This powder was later used in an active cathode material in a lithium ion battery slurry (mass loading of about 1 to 10 mg/cm²) and tested for charge/discharge performance rate and cycling retention in a Swagelok cell against Li metal, graphite, activated carbon or other anode material with a Celgard separator using LiPF₆ in about 1:1 ethylene carbon (EC):dimethyl carbonate (DMC) electrolyte (or other electrolyte). The cell could be charged and discharged in about 6 minutes with about 90% of maximum capacity and can reversibly do so for over 3,000 cycles and retain over about 90% of an initial capacity.

### Example 2

Two nanostructured LiMn₂O₄ powders were produced through a polymer templated sol-gel synthesis using nitrate or acetate salts to allow the study of their structural differences and electrochemical attributes. Nanostructured powders were synthesized using acetate salts produced materials with a round grain morphology (R-LMO) displayed the expected fast cycling kinetic and low capacity typical of small nanostructured LiMn₂O₄. Powders synthesized with nitrate salts produced nanostructured networks with a needle-like morphology (N-LMO) with similar cycling kinetics to the R-LMO system, but displayed higher overall capacity.

Fabrication of R-LMO and N-LMO made use of a sol-gel reaction where either acetate or nitrate Li and Mn(II) salts, respectively in a molar ratio 1.1 to 2 were mixed with colloidal poly(methyl methacrylate) spheres of 70 nm average diameter in water and heated at 95° C. for 30 minutes to evaporate water until the solution became viscous.

The 50 nm poly(methylmethacrylate) (PMMA) template spheres were prepared by emulsion polymerization of methyl methacrylate (Aldrich) monomer (MMA) using ammonium persulfate (APS, Alfa Aesar) as the initiator in deionized water; the method is a modified version of an established method from the literature. First, 165 mL DI water was bubbled with nitrogen for 20 min under stirring to remove any oxygen. Then, 0.3 mL ammonium lauryl sulfate (Aldrich), which serves as a surfactant, and 12.55 mL of MMA were added. The APS initiator solution was prepared separately by dissolving 0.075 g APS in 10 mL non-degassed water. The initiator solution was then added to the surfactant and monomer solution at 65° C. under stirring. The solution was heated to 73° C. and reacted for 3 hours. The prepared colloidal PMMA solution had a concentration of about 50 mg/mL, and was used without further purification. The average size of the PMMA colloids was determined to be 70 nm based on SEM.

To synthesize the round morphology nanostructured LiMn₂O₄ (R-LMO), 2.2 mmol of lithium acetate dihydrate (Sigma) and 4.0 mmol of manganese (II) acetate (Sigma) were mixed with 7.5 mL of the 50 mg/mL aqueous solution of 50 nm PMMA colloids. The solution was then heated and stirred in a round bottom flask for 20 minutes at 90° C. in an oil bath to evaporate part of the water. The resulting viscous solution was poured into a glass petri dish and left to dry for several hours in a fume hood. The resulting solid was heated in a muffle furnace with a ramp of 50° C./hour from room temperature to 550° C. and soaked for 1 hour. The nano-sized LMO powder was obtained by removing the solid from the petri dish surface.

The synthesis of needle-like nanostructured LiMn₂O₄ (N-LMO) followed the procedure of Example 1. In particular, 2.2 mmol of lithium nitrate (Sigma) and 4.0 mmol of manganese (II) nitrate tetrahydrate (Sigma) were used and the resulting solid formed in the petri dish was heated 50° C./hour from room temperature to 550° C. and then soaked at that temperature for 10 hours.

Imaging of both R-LMO and N-LMO samples was conducted to illustrate differences in the morphology of the materials. All peaks in the observed X-Ray Diffraction (XRD) patterns of both materials index to pure Li_{1.1}Mn₂O₄ (JCPDS: 00-035-0782) with Fd3m space group. Scherrer widths calculated for both patterns gave similar average crystallite sizes of 15 nm and 13 nm for R-LMO and N-LMO, respectively.

R-LMO images showed fused, rounded particles with pores formed only between the interconnected domains. By contrast, N-LMO images exhibited spikey structures composed of many needle-like projections. This structure results in both the higher surface area and the higher pore volume of the N-LMO. This morphology suggested that the N-LMO would have different electrochemical attributes than the R-LMO because similar domain sizes are accompanied by increased surface area that could lead to both more inactive surface sites and more Mn dissolution.

A closer look at the morphology of the nanostructures, seen through HR-TEM imaging showed other differences between the two materials. The R-LMO showed a somewhat curved surface with a range of surface facets. The <111> lattice plane, identified by a lattice spacing of ˜4.7 Å was observed for both structures. Surfaces parallel to the <111> lattice spacing direction correspond to (111) surfaces, whereas surfaces intersecting the <111> lattice planes were terminated with other faces such as (110) or (001). The TEM images showed that the needle-like structures of the N-LMO have the <111> lattice traveling parallel to the long direction, thus the surfaces all along the length of the structures correspond to (111) surfaces, with only the ends displaying non-(111) surfaces. Accordingly, the N-LMO displayed dominant (111) surface character, since the length is significantly longer than the radius.

In contrast, the R-LMO did not show any one dominant surface termination due to its relatively round morphology. It was noted that a true sphere would have less than half of its surfaces parallel to the <111> planes, but because the structure was partly faceted, this value could be a bit higher. It was safely assumed that no more than 50% of the surface was (111) terminated. Overall, it was concluded that N-LMO has a higher percentage of (111) surface termini than that of R-LMO.

N₂ porosimetry of the two nanostructured powders showed BET surface areas on the same order of magnitude for both R-LMO and N-LMO of 17 m²/g and 67 m²/g, respectively. The disparity in surface area can be understood from the BJH adsorption and desorption pore size distributions.

Unlike R-LMO, which demonstrated a range of pore sizes from 1 nm to 100 nm, the N-LMO demonstrated a range of pores sizes from 10 nm to 50 nm corresponding to the spaces between the needles and a second, narrower distribution for pores between the interconnected needle clusters from 50 nm to 70 nm. The disparity in surface area and pore size distribution between the two samples originated from the differing nanostructures of the two LiMn₂O₄ systems which could be seen from SEM images.

### Example 3

To further demonstrate the characteristics of the N-LMO materials, slurry electrodes were fabricated from the N-LMO and R-LMO powders for electrochemical testing in Swagelok cells. Slurries composed of 75% active mass, 10% carbon black, 5% carbon fibers and 10% PVDF were prepared with mass loadings between 1 and 2 mg/cm². Electrodes were cycled versus lithium metal with LiPF6 in EC:DMC 1:1 electrolyte.

For slurry electrode and cell fabrication, 36.5 mg of nanostructured LiMn₂O₄ powder was ground in a mortar and pestle with 5.0 mg of carbon black (Super P) and 2.5 mg carbon fiber (Sigma) for 5 minutes. Approximately 100 mg of a 5% polyvinylidene fluoride (PVDF) solution in N-Methyl-2-pyrrolidone (NMP) was added to the homogenized powder along with 10 additional drops of NMP. The resulting slurry was doctor bladed onto a stainless steel substrate with a height of ˜0.3 mm. The slurry was then place under a heat lamp for 1 hour to dry, and then transferred to a vacuum oven heated to ˜130° C. while pulling vacuum overnight. The dried slurry electrode sheet was then punched out using a 0.71 cm² puncher and the electrodes transferred to Swagelock cells which were assembled with Li metal in a glove box with 1M LiPF₆ in 1:1 EC:DMC as the electrolyte, and a glass fiber separator.

In the electrochemical analysis, Swagelok cells were cycled using a 4-channel Bio-Logic VSP potentiostat controlled using EC-Lab version 10.4 software with LiMn₂O₄ as the positive electrode, Li as the negative and Li as the reference. Samples were cycled using both galvanostatic and potentiostatic methods to produce charge/discharge curves and cyclic voltammetry used in the kinetic analysis (from 0.2, 0.5 and 1 mV/s).

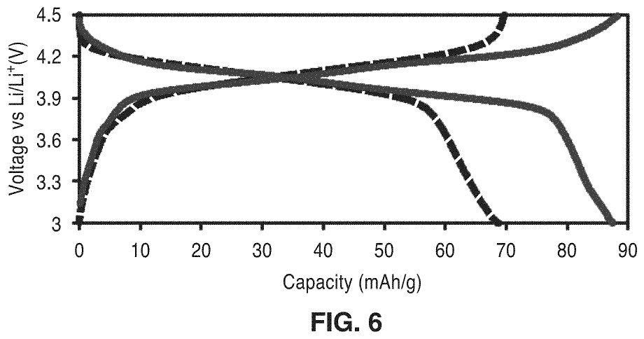

Galvanostatic cycling included charge/discharge curves, rate tests and normalized rate data of N-LMO and R-LMO electrodes. From the charge/discharge curves cycled at a relatively slow rate of 1 C in FIG. 6 it was observed that despite its higher surface area which should lead to reduced capacity, N-LMO achieves about 28% higher discharge capacity (88 mAh/g) than R-LMO (69 mAh/g). Of course, differing capacity alone did not eliminate the possibility that some kinetic limitation within the R-LMO could be preventing it from achieving the same capacity as N-LMO. If indeed kinetic limitations were a large contributing factor to the capacity disparity between the R-LMO and N-LMO, one would expect to observe poorer overall kinetics in the R-LMO at faster rates. The normalized capacity for both samples at varying C-rates, however, were nearly identical for both R-LMO and N-LMO, which indicated that the capacity difference of R-LMO compared to N-LMO was not related to kinetic differences between the two materials. Additional evidence of similar kinetic behavior was obtained through a kinetic analysis that uses cyclic voltammetry (CV) curves collected at different scan rates to decouple diffusion controlled or battery-like current from capacitive/pseudocapacitive current. There, it was found that the resulting capacitive current contributions for both samples were ˜85%, further supporting the claim that kinetics are not playing a significant role in capacity differences between the R-LMO and N-LMO samples.

As described previously, there are two primary mechanisms contributing to capacity reduction in nanostructured LiMn₂O₄. The first is due to the inactive surface of LiMn₂O₄ which originate from the inclusion of reduced Mn²⁺ in the surface 8a tetrahedral sites which normally hold Li⁺ in the bulk. The absence of Li⁺ in these surface tetrahedral sites reduces the number of active lithium positions, thereby decreasing the overall capacity substantially in high surface area nano-systems. Because relative surface area is inversely proportional to crystallite size, nanoscale materials with smaller domains should have higher surface area and thus more of these inactive sites.

The second mechanism for capacity reduction in nanostructured LiMn₂O₄ is dissolution of the surface Mn²⁺ upon direct contact with the electrolyte, followed by reduction of bulk Mn^{3+/4+} to form more Mn²⁺ on the freshly revealed surface. This effect is most evident upon charge but because a solid electrolyte interphase (SEI) is formed after the first cycle, direct contact with the electrolyte ceases unless the SEI layer is somehow disturbed. Because finely nanostructured systems of LiMn₂O₄ have high surface areas, the system is particularly vulnerable to dissolution during the first cycle. Subsequent cycles, however, show impressive reversibility, suggesting that the SEI in these systems are relatively stable.

The (111) terminated surfaces in LiMn₂O₄ have been shown to resist dissolution in non-aqueous electrolytes in contrast to the non-(111) terminated surfaces. Because the round morphology of R-LMO displays far less (111) surfaces than N-LMO, which has (111) terminated surfaces along the length of the needles, it was anticipated that N-LMO will suffer less from surface dissolution and thus display higher capacity than R-LMO. Indeed, the increased dissolution resistance of the N-LMO explained the improved capacity in N-LMO compared to R-LMO electrode materials with no substantial difference in kinetics.

From these results, it was concluded that much of the capacity loss observed in nanostructured LiMn₂O₄ occurs during the first cycle, and therefore having resistance to this initial dissolution will allow for much higher capacity for subsequent cycles.

### Example 4

To further demonstrate the presence of reduced dissolution in N-LMO compared to R-LMO electrode materials, several cells were examined after cycling for signs of dissolution. One sign of dissolution was the presence Mn that dissolved into the electrolyte that was plated out on the counter electrode. The lithium metal anode from each cell was analyzed using X-ray photoelectron spectroscopy (XPS) for evidence of plated manganese metal. Lithium metal surface analysis was ideal for identifying relative amounts of solvated Mn₂₊ in the electrolyte as the ions are prone to plating onto the Li metal by the spontaneous redox reaction: 2Li⁰+Mn²⁺→2Li⁺+Mn⁰, E_{cell}°=−1.86.

The R-LMO and N-LMO electrodes were cycled in Swagelok cells using Li as counter electrode at C/10 for one charge-discharge cycle. Cells were then disassembled and the Li foil was used for XPS measurements to identify the relative ratio of Mn to Li (Mn/Li+Mn)).

Mn 2p and Li 1s XPS of the surface of the lithium metal used as anodes during the cycling was conducted on N-LMO and R-LMO cells at C/5 for one cycle. Total Mn deposited onto the Li anode used for R-LMO was 1.5% (Mn/(Mn+Li)) and total Mn deposited onto Li anode used for N-LMO was 0.3% (Mn/(Mn+Li)). The fivefold higher concentration of Mn deposited onto the Li from the R-LMO cell compared to the N-LMO suggests dissolution was higher for R-LMO, demonstrating that N-LMO is comparatively less susceptible to dissolution than R-LMO.

The lower Mn/(Li+Mn) % seen at the surface of the Li foil counter electrode of the N-LMO suggest that despite having higher surface area, less Mn was dissolved from N-LMO than from the R-LMO after the first cycle. The lower concentration of Mn in the electrolyte of the N-LMO cell compared to the R-LMO cell after the first cycle supports the theory that N-LMO is more resistant to dissolution than R-LMO. This resistance to Mn dissolution of the N-LMO electrode corroborates the hypothesis that the higher capacity of N-LMO is due to the preservation of active material in the N-LMO sample. Perhaps more importantly, it shows that simple solution processing routes can lead to nanostructured LiMn₂O₄ with both a favorable nanoscale structure and favorable surfaces faceting for application in high power density Li-ion energy storage devices.

From the description herein, it will be appreciated that that the present disclosure encompasses multiple embodiments which include, but are not limited to, the following:

1. A method for producing a nanostructured pseudocapacitive material, the method comprising: (a) mixing a lithium metal salt and a manganese metal salt with a colloidal polymer suspended in an aqueous solvent to produce a colloidal mixture; (b) gelling the colloidal mixture to form a gel; (c) drying the gel to remove excess solvent; and (d) thermally processing the gel to remove the polymer and to crystallize the gel to provide a free-standing nanostructured powder.

2. The method of any preceding or following embodiment, wherein the lithium metal salt is lithium nitrate and the manganese metal salt is manganese nitrate.

3. The method of any preceding or following embodiment, wherein gelling the colloidal mixture is a process selected from the group of processes consisting of stirring, heating and stirring and heating the colloidal mixture to produce a gel.

4. The method of any preceding or following embodiment, wherein the nanostructured powder is formed from grains with a diameter of 40 nm or less.

5. The method of any preceding or following embodiment, further comprising incorporating one or more additional lithium or manganese metals into the nanostructure as a dopant.

6. The method of any preceding or following embodiment, further comprising incorporating one or more additional metals into the nanostructure as a dopant selected from the group of metals consisting of Mg and Ru.

7. The method of any preceding or following embodiment, wherein the thermal processing of the dried gel comprises:

heating the dried gel to a temperature between about 350° C. to about 750° C. for a period of about 1 hour to about 24 hours.

8. The method of any preceding or following embodiment, wherein the thermal processing of the dried gel comprises: heating the dried gel from an ambient temperature to a maximum temperature with a ramp rate of between about 50° C./h and about 100° C./h.

9. The method of any preceding or following embodiment, further comprising: heating the dried gel from an ambient temperature to a soaking temperature of between about 350° C. to about 750° C. with a ramp rate of between about 50° C./h and about 100° C./h; and soaking the dried gel at the soaking temperature for a time duration in a range of about 1 hour to about 30 hours.

10. A method for producing a dissolution resistant, nanoporous LiMn₂O₄ cathode material, comprising: (a) combining a lithium nitrate and manganese nitrate with a solution of a polymeric template to obtain a mixture; (b) stirring the mixture to form a gel; (c) drying the gel to remove any remaining solution; and (d) heating the dried gel to form nanostructured LiMn₂O₄ material, wherein the nanostructure includes (111) crystal facets at least partially exposed along a lateral periphery of the nanostructure.

11. The method of any preceding or following embodiment, wherein the solution of the polymeric template comprises polymeric colloids dispersed in water.

12. The method of any preceding or following embodiment, further comprising: heating the mixture while stirring the mixture to form a gel.

13. The method of any preceding or following embodiment, the heating of the dried gel, further comprising: heating the dried gel from an ambient temperature to a soaking temperature of between about 550° C. to about 750° C. with a ramp rate of between about 50° C./h and about 100° C./h; and soaking the dried gel at the soaking temperature for a time duration in a range of about 1 hour to about 30 hours.

14. The method of any preceding or following embodiment, wherein the nanostructured LiMn₂O₄ material is formed from LiMn₂O₄ grains with a diameter of 40 nm or less.

15. The method of any preceding or following embodiment, wherein the nanostructured LiMn₂O₄ comprises elongated LiMn₂O₄ nanostructures, with (111) crystal facets substantially aligned with a longitudinal direction of the nanostructure.

16. A nanoporous LiMn₂O₄ composition, comprising: (a) a porous network of interconnected LiMn₂O₄ nano-sized grains, the grains having a plurality of elongated crystallites with dominant <111> surface sites; (b) wherein the network has a porosity to allow an electrolyte to permeate between the connected LiMn₂O₄ grains.

17. The composition of any preceding or following embodiment, wherein the elongate crystallites have a lateral dimension in a range of 1 nm to 100 nm and an aspect ratio between 1.5 and 50.

18. The composition of any preceding or following embodiment, wherein the porous network has a pore size between grains of less than 50 nm in diameter.

19. The composition of any preceding or following embodiment, wherein the nanostructured LiMn₂O₄ material is formed from LiMn₂O₄ grains with a diameter of 50 nm or less.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A method for producing a nanostructured pseudocapacitive material, the method comprising:
(a) mixing a lithium metal salt and a manganese metal salt with a colloidal polymer suspended in an aqueous solvent to produce a colloidal mixture;
(b) gelling the colloidal mixture to form a gel;
(c) drying the gel to remove excess solvent; and
(d) thermally processing the gel to remove the polymer and to crystallize the gel to provide a free-standing nanostructured powder.

2. The method of claim 1, wherein the lithium metal salt is lithium nitrate and the manganese metal salt is manganese nitrate.

3. The method of claim 1, wherein gelling the colloidal mixture is a process selected from the group of processes consisting of stirring, heating and stirring and heating the colloidal mixture to produce a gel.

4. The method of claim 1, wherein the nanostructured powder is formed from grains with a diameter of 40 nm or less.

5. The method of claim 1, further comprising incorporating one or more additional lithium or manganese metals into the nanostructure as a dopant.

6. The method of claim 1, further comprising incorporating one or more additional metals into the nanostructure as a dopant selected from the group of metals consisting of Mg and Ru.

7. The method of claim 1, wherein the thermal processing of the dried gel comprises:
heating the dried gel to a temperature between about 350° C. to about 750° C. for a period of about 1 hour to about 24 hours.

8. The method of claim 1, wherein the thermal processing of the dried gel comprises:
heating the dried gel from an ambient temperature to a maximum temperature with a ramp rate of between about 50° C./h and about 100° C./h.

9. The method of claim 1, further comprising:
heating the dried gel from an ambient temperature to a soaking temperature of between about 350° C. to about 750° C. with a ramp rate of between about 50° C./h and about 100° C./h; and
soaking the dried gel at the soaking temperature for a time duration in a range of about 1 hour to about 30 hours.

10. A method for producing a dissolution resistant, nanoporous LiMn₂O₄ cathode material, comprising:
(a) combining a lithium nitrate and manganese nitrate with a solution of a polymeric template to obtain a mixture;
(b) stirring the mixture to form a gel;
(c) drying the gel to remove any remaining solution; and
(d) heating the dried gel to form nanostructured LiMn₂O₄ material, wherein the nanostructure includes (111) crystal facets at least partially exposed along a lateral periphery of the nanostructure.

11. The method of claim 10, wherein the solution of the polymeric template comprises polymeric colloids dispersed in water.

12. The method of claim 10, further comprising:
heating the mixture while stirring the mixture to form a gel.

13. The method of claim 10, said heating of the dried gel, further comprising:
heating the dried gel from an ambient temperature to a soaking temperature of between about 550° C. to about 750° C. with a ramp rate of between about 50° C./h and about 100° C./h; and
soaking the dried gel at the soaking temperature for a time duration in a range of about 1 hour to about 30 hours.

14. The method of claim 10, wherein the nanostructured LiMn₂O₄ material is formed from LiMn₂O₄ grains with a diameter of 40 nm or less.

15. The method of claim 10, wherein the nanostructured LiMn₂O₄ comprises elongated LiMn₂O₄ nanostructures, with (111) crystal facets substantially aligned with a longitudinal direction of the nanostructure.

16. A nanoporous LiMn₂O₄ composition, comprising:
(a) a porous network of interconnected LiMn₂O₄ nano-sized grains, said grains having a plurality of elongated crystallites with dominant <111> surface sites;
(b) wherein the network has a porosity to allow an electrolyte to permeate between the connected LiMn₂O₄ grains.

17. The composition of claim 16, wherein said elongate crystallites have a lateral dimension in a range of 1 nm to 100 nm and an aspect ratio between 1.5 and 50.

18. The composition of claim 16, wherein the porous network has a pore size between grains of less than 50 nm in diameter.

19. The composition of claim 16, wherein the nanostructured LiMn₂O₄ material is formed from LiMn₂O₄ grains with a diameter of 50 nm or less.
